(19) United States
(12) Patent Application Publication
(10) Pub. No.: US 2019/0069232 A1
(43) Pub. Date: Feb. 28, 2019

(54) HYBRID DEVICE, METHOD OF OPERATING SAME, AND ORDERING DEVICE

(71) Applicant: SK Planet Co., Ltd., Seoul (KR)

(72) Inventor: Joon Sung LEE, Seongnam-si (KR)

(73) Assignee: SK Planet Co., Ltd.

(21) Appl. No.: 16/115,011

(22) Filed: Aug. 28, 2018

(30) Foreign Application Priority Data
Aug. 31, 2017 (KR) 10-2017-0110891

(51) Int. Cl. H04W 52/02; G06Q 30/06; H04W 4/80; G06Q 20/32

(52) U.S. Cl. CPC H04W 52/0209; G06Q 20/327; H04W 4/80; G06Q 30/0637

(57) ABSTRACT

The present disclosure provides a hybrid device, a method of operating the same, and an ordering device capable of improving user convenience and minimizing battery consumption in a user terminal according to the use of the ordering device by omitting a pairing procedure between the ordering device and the user terminal that is required to use the ordering device that supports quick product purchase through button input alone.

### CROSS-REFERENCE TO RELATED APPLICATIONS

This application claims priority to Korean Patent Application No. 10-2017-0110891, filed on Aug. 31, 2017, the entire contents of which are incorporated herein by reference.

### TECHNICAL FIELD

The present disclosure relates to an ordering device supporting quick product purchase through button input alone. In addition, the present disclosure relates to the ordering device for ordering without any pairing procedure between the ordering device and a user terminal.

### BACKGROUND

Recently, global commerce service providers such as Amazon or Alibaba have expanded/enhanced their own capability by offering fresh foods and direct delivery and have also extended purchase channels to spaces such as an office and a living room within the home through IoT devices such as Echo or Dash.

In order to guarantee the loyalty of customers in light of this trend, it is required to provide a new purchase experience and improve the competitiveness of a particular product category.

In connection with this, an IoT device (hereinafter, referred to as an “ordering device”) has recently been proposed to enable quick product purchase through simple button input alone.

Through the ordering device for simple and quick online purchase, a new purchase experience is provided to a user and convenience of the purchase is also guaranteed.

However, it is inconvenient to perform a pairing procedure between the ordering device and the user terminal in order to use the ordering device. In addition, there is also a disadvantage in that a battery of the user terminal is rapidly consumed when the pairing procedure between the ordering device and the user terminal is repeated.

### SUMMARY

The present disclosure has been made to solve the above-described problems, and an aspect of the present disclosure is to enable the use of an ordering device without any pairing procedure between the ordering device and a user terminal when the ordering device supports quick product purchase through button input alone.

In accordance with one form of the present disclosure, a hybrid device is provided. The hybrid device includes: a processor configured to process order packet information received from an ordering device; and a memory configured to store at least one command executed through the processor, wherein the at least one command comprises: a reception command for receiving the order packet information generated by the ordering device according to a first communication scheme; and a transmission command for transmitting the order packet information to the service server according to a second communication scheme, which is different from the first communication scheme when the order packet information is received, thereby the service server being able to process the order packet information.

Specifically, the first communication scheme may be determined such that an amount of power consumption required by the first communication scheme to transmit the order packet information is smaller than an amount of power consumption required by the second communication scheme to transmit the order packet information.

Specifically, the first communication scheme may a Bluetooth Low Energy (BLE) communication scheme and the second communication scheme may be a Wi-Fi communication scheme.

Specifically, the hybrid device may further comprise: a first communication unit configured to receive the order packet information through the Bluetooth Low Energy (BLE) communication scheme; and a second communication unit configured to transmit the order packet information through the Wi-Fi communication scheme.

Specifically, the hybrid device may further comprise: a power unit configured to receive driving power of the hybrid device through a Universal Serial Bus (USB) interface from another device receiving power.

Specifically, it may be determines whether there is user consent to process the order packet information from the user terminal when the order packet information is transmitted according to the second communication scheme.

Specifically, the order packet information may be processed when it is determines that there is user consent to process the order packet information.

In accordance with another form of the present disclosure, an ordering device is provided. The ordering device includes: a processor configured to process a purchase request; and a memory configured to store at least one command executed through the processor, wherein the at least one command comprises: a generation command for generating order packet information when button input related to the quick purchase request is identified; and a transmission command for transmitting the order packet information to the hybrid device according to a first communication scheme, thereby the hybrid device being able to transmit the order packet information to a service server according to a second communication scheme, which is different from the first communication scheme.

Specifically, the first communication scheme may be determined such that an amount of power consumption required by the first communication scheme to transmit the order packet information is smaller than an amount of power consumption required by the second communication scheme to transmit the order packet information.

Specifically, the first communication scheme may be a Bluetooth Low Energy (BLE) communication scheme.

Specifically, the ordering device may further comprise a power unit configured to receive driving power of the ordering device from battery power.

In accordance with another form of the present disclosure, a method of operating a hybrid device is provided. The method includes: receiving the order packet information generated by the ordering device according to a first communication scheme; and transmitting the order packet information to the service server according to a second communication scheme, which is different from the first communication scheme when the order packet information is received, thereby the service server being able to process the order packet information.

Specifically, the first communication scheme may be determined such that an amount of power consumption required by the first communication scheme to transmit the order packet information is smaller than an amount of power consumption required by the second communication scheme to transmit the order packet information.

Specifically, the first communication scheme may be a Bluetooth Low Energy (BLE) communication scheme and the second communication scheme may be a Wi-Fi communication scheme.

Specifically, the method of operating a hybrid device may further comprise: receiving driving power of the hybrid device through a Universal Serial Bus (USB) interface from another device receiving power.

A hybrid device, a method of operating the same, and an ordering device according to an embodiment of the present disclosure enable the ordering device to support quick product purchase through button input without a pairing procedure between the ordering device and the user terminal, thereby improving user convenience and minimizing battery consumption in a user terminal.

### DRAWINGS

The above and other aspects, features and advantages of the present disclosure will be more apparent from the following detailed description taken in conjunction with the accompanying drawings, in which:

FIG. 1 is a block diagram schematically illustrating a smart order system in one form of the present disclosure;

FIG. 2 is a block diagram schematically illustrating an ordering device in one form of the present disclosure;

FIG. 3 illustrates a hardware system for implementing the ordering device in one form of the present disclosure;

FIG. 4 is a block diagram schematically illustrating the hybrid device in one form of the present disclosure;

FIG. 5 illustrates a hardware system for implementing the hybrid device in one form of the present disclosure;

FIG. 6 is a block diagram schematically illustrating the service server in one form of the present disclosure;

FIG. 7 illustrates a hardware system for implementing the service server in one form of the present disclosure;

FIG. 8 is a flowchart illustrating the operation flow of the smart order system in one form of the present disclosure;

FIG. 9 is a flowchart schematically illustrating the operation flow of the ordering device in one form of the present disclosure;

FIG. 10 is a flowchart schematically illustrating the operation flow of the hybrid device in one form of the present disclosure; and

FIG. 11 is a flowchart schematically illustrating the operation flow of the service server in one form of the present disclosure.

### DETAILED DESCRIPTION

It should be noted that the technical terms in the specification are merely used for describing a specific embodiment but do not limit the scope of the present disclosure. Further, the technical terms in the specification should be construed as a meaning generally understood by those skilled in the art unless the terms are defined as another meaning and should not be construed as an excessively inclusive meaning or an excessively exclusive meaning. When a technical term used in the specification is an incorrect technical term which does not accurately express the idea of the present disclosure, the technical term should be replaced with the correct technical term which can be understood by those skilled in the art. Further, the general terms used in the present disclosure should be interpreted in the context according to the dictionary definition and should not be construed as possessing an excessively limited meaning.

Hereinafter, exemplary embodiments of the present disclosure will be described in detail with reference to the accompanying drawings, equal or similar elements are assigned an equal reference numeral, and an overlapping description thereof will be omitted. Further, in the following description of the present disclosure, a detailed description of known technologies incorporated herein will be omitted when it may make the subject matter of the present disclosure rather unclear. Further, it should be noted that the accompanying drawings are intended only for the easy understanding of the technical idea of the present disclosure, and the spirit of the present disclosure should not be construed as being limited by the accompanying drawings. In addition to the accompanying drawings, the spirit of the present disclosure should be construed to cover all modifications, equivalents, and alternatives thereof.

Hereinafter, an embodiment of the present disclosure will be described with reference to the accompanying drawings.

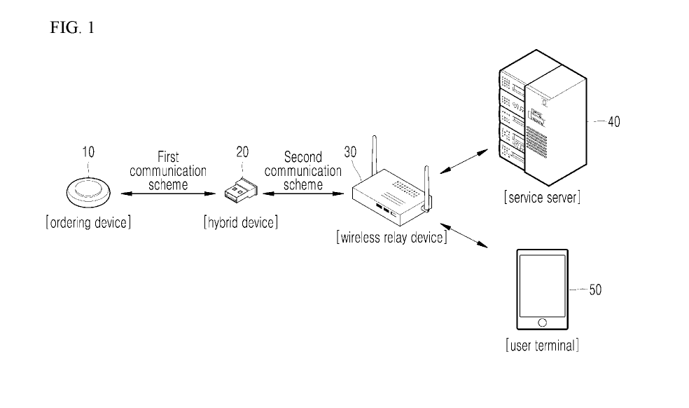

FIG. 1 illustrates a smart order system according to an embodiment of the present disclosure.

As illustrated in FIG. 1, the smart order system according to an embodiment of the present disclosure may include an ordering device 10, a hybrid device 20, a wireless relay device 30, a service server 40, and a user terminal 50.

The ordering device 10 refers to an IoT device configured to support quick product purchase. For example, when a user request (a quick product purchase request) is identified through button input, the ordering device 10 may make a request for quick purchase of the product by transferring order packet information to the service server 40.

The ordering device 10 may support the quick purchase of the product without user action such as access to the service server 40, login, product search, order, and payment.

The hybrid device 20 refers to a device configured to receive order packet information generated when a button of the ordering device 10 is input and transferring the order packet information to the service server 40.

The wireless relay device 30 refers to a device configured to provide a radio access environment (for example, Wi-Fi), in which access to the service server 40, the hybrid device 20 and the user terminal 50 is possible. An Access Point (AP) may be an example of the wireless relay device 30.

The service server 40 refers to a server configured to process an quick product purchase requested by the ordering device 10. When order packet information generated and received through the hybrid device 20 when a button of the ordering device 10 is input, the service server 40 may process the quick product purchase by identifying user consent from the user terminal 50 and then processing the corresponding order packet information.

The order packet information may include device identification information (for example, a MAC address or serial number) of the ordering device 10, and the service server 40 may manage the device identification information by mapping, in advance, the identification information of the user terminal 50 (for example, a phone number and application identification information) to information on particular products to be quickly purchased, payment means, and the delivery destination.

The service server 40 may be implemented in the form of, for example, a web server, a database server, or a proxy server, or may be implemented as a computerized system through installation of one or more of various pieces of software that allow a network load distribution mechanism or a service device to operate on the Internet or another network. Further, the network may be an http network, a private line, an intranet, or another network, and a connection between elements within an advertisement providing system according to an embodiment of the present disclosure may be made through a security network to prevent data from being compromised by an arbitrary hacker or another third party. The service server 40 may include a plurality of database servers, and the database servers may be connected to the hybrid device 30 and the user terminal 50 through a predetermined type of network connection including distributed database server architecture.

The user terminal 50 refers to a terminal in which an application related to a product purchase service is installed, and may support separate services such as product searching, product ordering, and tracking as well as services such as user configuration for using the ordering device 10 and quick produce purchase through various User Interfaces (UIs) provided by the application.

The user terminal 50 may be, for example, a smart phone, a portable terminal, a mobile terminal, a Personal Digital Assistant (PDA), a Portable Multimedia Player (PMP) terminal, a telematics terminal, a navigation terminal, a Personal Computer (PC), a notebook computer, a slate PC, a tablet PC, an ultrabook, a wearable device (for example, a watch-type terminal (smart watch), a glasses-type terminal (smart glasses), or a Head-Mounted Display (HMD)), a WiBro terminal, an Internet Protocol Television (IPTV) terminal, a smart TV, a digital broadcast terminal, a television, a 3D television, a home theater system, an Audio Video Navigation (AVN) terminal, an Audio/Video (A/V) system, or a flexible terminal, but the present disclosure is not limited thereto, and may include any device in which the application can be installed.

The smart order system according to an embodiment of the present disclosure can process the quick product purchase using the ordering device 10 through the above-described configuration.

Meanwhile, in the conventional art, the hybrid device 20 is excluded from the configuration of the system, and thus a pairing procedure for a connection between the ordering device 10 and the user terminal 50 must first be performed in order to use the ordering device 10. After the connection with the user terminal 50, the ordering device 10 may acquire access information of the wireless relay device 30 and access information of the service server 40 from the user terminal 50 and directly link to the service server 40 through the wireless relay device 30.

As a result, in the conventional art, there is inconvenience in that the pairing procedure between the ordering device 10 and the user terminal 50 is necessary in order to use the ordering device 10, and also, there is a disadvantage in that a battery of the user terminal 50 is rapidly consumed if the pairing procedure between the ordering device 10 and the user terminal 50 is repeated.

Accordingly, an embodiment of the present disclosure proposes a new method of making the normal use of the ordering device 10 possible without any pairing procedure between the ordering device 10 and the user terminal 50, and, hereinafter, each element within a smart order system for implementing the new method will be described in more detail.

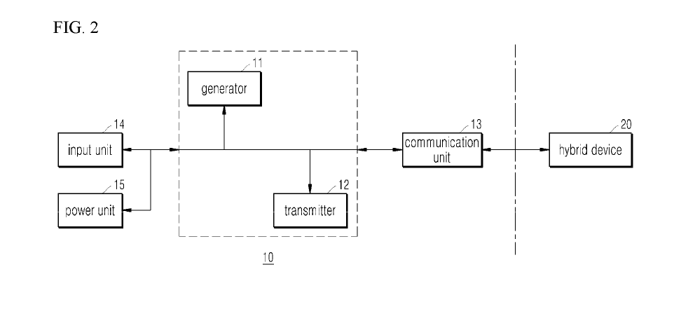

FIG. 2 is a block diagram schematically illustrating the ordering device 10 according to an embodiment of the present disclosure.

As illustrated in FIG. 2, the ordering device 10 according to an embodiment of the present disclosure may include a generator 11 configured to generate order packet information and a transmitter 12 configured to transmit order packet information.

All or at least some of the core elements of the ordering device 10 including the generator 11 and the transmitter 12 may be implemented in the form of a software module or a hardware module executed by a processor or in the form of a combination of the software module and the hardware module.

The software module may be understood as, for example, an instruction executed by the processor for processing calculations within the ordering device 10, and the instruction may have a form installed in a memory within the ordering device 10.

Meanwhile, the ordering device 10 according to an embodiment of the present disclosure may further include a communication unit 13, which is an RF module supporting communication with the hybrid device 20, an input unit 14 configured to receive button (RIP) input corresponding to an quick purchase request from the user, and a power unit 15 configured to receive driving power of the ordering device 10 from battery power as well as the above-described elements.

As a result, the ordering device 10 according to an embodiment of the present disclosure may make a request for an quick product purchase through the core elements including the generator 11 and the transmitter 12, and, hereinafter, the core elements of the ordering device 10 for implementing the quick product purchase will be described in more detail.

The generator 11 performs a function of generating order packet information.

More specifically, when button input according to the quick purchase request is identified, the generator 11 generates order packet information for requesting the quick product purchase.

At this time, when the button input is identified, the generator 11 may minimize power consumption of battery power by generating order packet information through a method of switching an operation mode of the ordering device 10, which is normally in a sleep mode, to an active mode.

The transmitter 12 performs a function of transmitting order packet information.

More specifically, when order packet information is generated in response to button input, the transmitter 12 transmits the generated order packet information to the hybrid device 20 according to a first communication scheme.

At this time, when the order packet information is received according to the first communication scheme, the hybrid device 20 may make a request for processing the order packet information by transmitting the received order packet information to the service server 40 according to a second communication scheme, which is different from the first communication scheme.

The first communication scheme refers to a communication scheme requiring a smaller amount of power for transmitting order packet information than that required by the second communication scheme, and Bluetooth Low Energy (BLE) may be an example corresponding thereto.

In connection with this, the second communication scheme may correspond to Wi-Fi, which is a communication scheme supported by the wireless relay device 30.

Meanwhile, when the order packet information transmitted from the hybrid device 20 according to the second communication scheme is received through the wireless relay device 30, the service server 40 may identify whether there is user consent to process the order packet information from the user device 50, and when the user consent is confirmed, process the order packet information.

The identification of whether the user consent to process the order packet information is confirmed may be performed, through, for example, a pop-up push message based on an application within the user terminal 50.

As a result, when button input is identified, the ordering device 10 according to an embodiment of the present disclosure may perform only the operation of generating order packet information by switching the operation state from a normal sleep mode to an active mode and transmitting the order packet information to the hybrid device 20 through the first communication scheme, for example, Bluetooth Low Energy (BLE), consuming a relatively small amount of power compared to that consumed by the second communication scheme between the hybrid device 20 and the service server 30, thereby minimizing power consumption of battery power.

It has been described that each element within the ordering device 10 may be implemented in the form of a software module or a hardware module executed by the processor or in the form of a combination of the software module and the hardware module.

As described above, the software module and the hardware module executed by the processor and the combination of the software module and the hardware module may be implemented based on a hardware system (for example, a computer system).

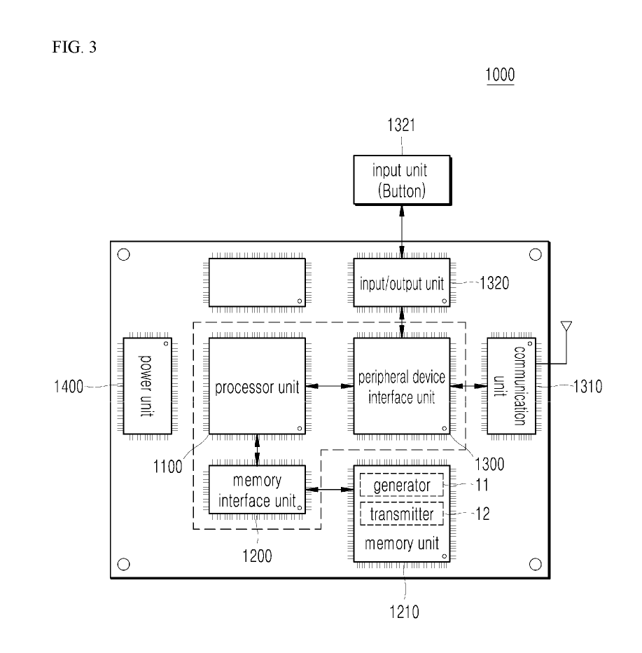

Accordingly, a hardware system 1000 for implementing the ordering device 10 according to an embodiment of the present disclosure will be described below with reference to FIG. 3.

For reference, the following description is an example for implementing each element within the above-described ordering device 10 as the hardware system 1000, and it is noted that each element and the operation thereof may be different from those in the actual system.

As illustrated in FIG. 3, the hardware system 1000 according to an embodiment of the present disclosure may include a processor unit 1100, a memory interface unit 1200, a peripheral device interface unit 1300, and a power unit 1400 (corresponding to the “power unit” of FIG. 2) configured to receive driving power from battery power.

The elements within the hardware system 1000 may be individual elements, or may be integrated into one or more integrated circuits or combined via a bus system (not shown).

The bus system corresponds to abstractions indicating one or more individual physical buses, communication lines/interfaces, multi-drop, and/or point-to-point connections connected by appropriate bridges, adaptors, and/or controllers.

The processor unit 1100 may serve to execute various software modules stored in the memory unit 1210 by communicating with the memory unit 1210 through the memory interface unit 1200 in order to perform various functions in the hardware system.

The memory unit 1210 may store the generator 11 and the transmitter 12, which are the core elements of the ordering device 10 described with reference to FIG. 2, in the software module form, and may further store an Operating System (OS).

The operating system (for example, an embedded operating system such as iOS, Android, Darwin, RTXC, LINUX, UNIX, OSX, WINDOWS, or VxWorks) includes various procedures for controlling and managing general system tasks (for example, memory management, storage device control, and power management), an instruction set, a software component, and/or a driver, and serves to make communication between various hardware modules and software modules easy.

For reference, the memory 1210 includes a cache, a main memory, and a secondary memory, but is not limited thereto, and may include a memory layer structure. The memory layer structure may be implemented through a predetermined combination of, for example, RAM (for example, SRAM, DRAM, or DDRAM), ROM, FLASH, a magnetic and/or optical storage device (for example, a disk drive, a magnetic tape, a Compact Disk (CD), and a Digital Video Disc (DVD)).

The peripheral interface unit 1300 enables communication between the processor unit 1100 and peripheral devices.

The peripheral devices provide different functions to the hardware system 1000 and may include, for example, a communication unit 1310 (corresponding to the “communication unit” of FIG. 2) and an input/output unit 1320 according to an embodiment of the present disclosure.

The communication device 1310 serves to provide a communication function with the hybrid device 20. To this end, the communication device 1310 includes, for example, an antenna system, an RF transceiver, one or more amplifiers, a tuner, one or more oscillators, a digital signal processor, a CODEC chipset, and a memory, but is not limited thereto, and may include a known circuit for performing the function.

Communication schemes supported by the communication unit 1310 may include Bluetooth Low Energy (BLE) corresponding to the first communication scheme, but are not limited thereto, and may include any communication scheme, such as BLE, consuming a relatively small amount of power compared to other communication schemes.

Further, the input/output unit 1320 serves as a controller for controlling other I/O devices linked with the hardware system, and may perform a function of identifying button input of an input unit 1321 (corresponding to the “input unit” of FIG. 2) according to an embodiment of the present disclosure.

As a result, according to the above configuration, each element within the ordering device 10 stored in the software module form in the memory unit 1210 may be linked to the communication unit 1310 and the input/output unit 1320 through the memory interface unit 1200 and the peripheral device interface unit 1300 in the form of instructions executed by the processor 1100 based on driving power supplied by the power unit 1400, thereby making a request for quick product purchase.

Hereinafter, for convenience of description, each element of the ordering device 10 will be described based on a linkage with the hardware system 1000 with reference to FIG. 3.

The generator 11 performs a function of generating order packet information.

More specifically, when button input of the input unit 1321 according to an quick purchase request is identified through the input/output unit 1320, the generator 11 generates order packet information to make a request for the quick product purchase and transfers the generated order packet information to the transmitter 12.

At this time, when the button input is identified, the generator 11 may minimize power consumption of battery power by generating order packet information through a method of switching an operation mode of the ordering device 10, which is normally in a sleep mode, to an active mode.

The transmitter 12 performs a function of transmitting order packet information.

More specifically, when the order packet information according to the button input is received from the generator 11, the transmitter 12 transmits the received order packet information to the hybrid device 20 according to a first communication scheme, for example, a Bluetooth Low Energy communication scheme supported by the communication unit 1310.

At this time, when the order packet information is received according to the first communication scheme, the hybrid device 20 makes a request for processing the order packet information by transmitting the received order packet information to the service server 40 according to a second communication scheme, for example, a Wi-Fi communication scheme, which is different from the first communication scheme.

The ordering device 10 according to an embodiment of the present disclosure has been described above, and the hybrid device 20 will next be described below.

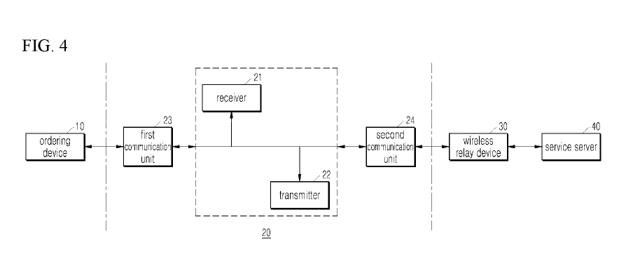

FIG. 4 is a block diagram schematically illustrating the hybrid device 20 according to an embodiment of the present disclosure.

As illustrated in FIG. 4, the hybrid device 20 according to an embodiment of the present disclosure may include a receiver 21 configured to receive order packet information and a transmitter 22 configured to transmit order packet information.

All or at least some of the core elements of the hybrid device 20 including the receiver 21 and the transmitter 22 may be implemented in the form of a software module or a hardware module executed by the processor or in the form of a combination of the software module and the hardware module.

The software module may be understood to be an instruction executed by the processor for processing calculations within the hybrid device 20, and the instruction may take the form of being installed in the memory within the hybrid device 20.

Meanwhile, the hybrid device 20 according to an embodiment of the present disclosure may further include a first communication unit 23, which is an RF module supporting communication with the ordering device 10, a second communication unit 24, which is an RF module supporting communication with the service server 40, and a power unit 25 configured to receive driving power from another device, to which constant power is supplied, through, for example, a Universal Serial Bus (USB) interface as well as the above-described elements.

As a result, the hybrid device 20 according to an embodiment of the present disclosure may transfer order packet information generated by the ordering device 10 to the service server 40 through the core elements including the generator 21 and the transmitter 22, and, hereinafter, the core elements of the hybrid device 20 for implementing the same will be described in more detail.

The receiver 21 performs a function of receiving order packet information.

More specifically, the receiver 21 receives order packet information, which is generated when button input occurs in the ordering device 10, from the ordering device 10.

At this time, the receiver 21 receives order packet information from the ordering device 10 through a first communication scheme, for example, Bluetooth Low Energy (BLE), consuming a relatively small amount of power for transmitting order packet information compared to a second communication scheme, which is a communication scheme between the hybrid device 20 and the service server 40.

In connection with this, when the button input from the user is identified, the ordering device 10 generates order packet information and transmits the generated order packet information to the hybrid device 20 according to the first communication scheme, for example, Bluetooth Low Energy (BLE).

The transmitter 22 performs a function of transmitting order packet information.

More specifically, when the order packet information according to the button input is received from the ordering device 10 according to the first communication scheme, the transmitter 12 may make a request for processing order packet information by transmitting the received order packet information to the service server 40 according to the second communication scheme, for example, a Wi-Fi communication scheme, which is different from the first communication scheme and is supported by the wireless relay device 30.

In connection with this, when the order packet information transmitted from the hybrid device 20 according to the second communication scheme is received through the wireless relay device 30, the service server 40 may identify whether there is user consent to process the order packet information from the user terminal 50, and when the user consent is confirmed, process the order packet information.

The identification of whether the user consent to process the order packet information is confirmed may be performed, through, for example, a pop-up push message based on an application within the user terminal 50.

As a result, the hybrid device 20 according to an embodiment of the present disclosure may transfer order packet information generated by the ordering device 10 to the service server 40 to process the order packet information, and the service server 40 and the user terminal 50 identify only whether there is user consent through an application-based popup push message, so that the ordering device 10 can be used normally without any pairing procedure between the ordering device 10 and the user terminal 50. Further, since the hybrid device 20 adapts a scheme of receiving driving power from another device, to which constant power is supplied, through, for example, a Universal Series Bus (USB) interface, there is no worry about exhaustion of driving power.

It has been described that the elements within the hybrid device 20 may be implemented in the form of a software module or a hardware module executed by the processor or in the form of a combination of the software module or the hardware module.

As described above, the software module and the hardware module executed by the processor and the combination of the software module and the hardware module may be implemented by a hardware system (for example, a computer system).

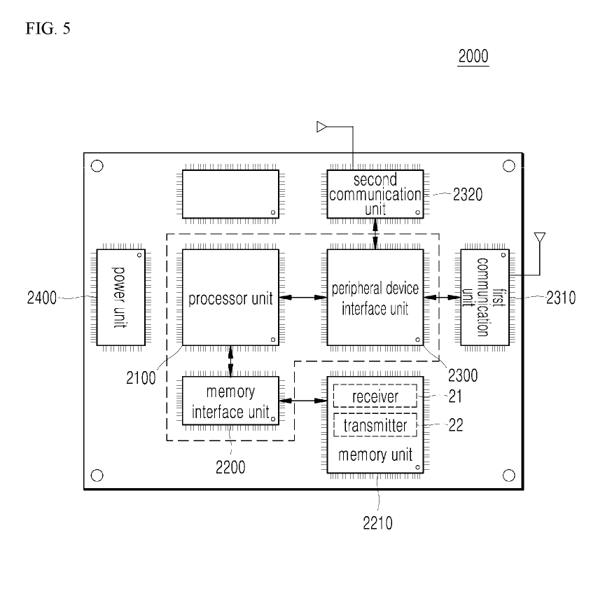

Accordingly, hereinafter, a hardware system 2000 for implementing the hybrid device 20 according to an embodiment of the present disclosure will be described with reference to FIG. 5.

For reference, the following description is an example for implementing the elements within the above-described hybrid device 20 as the hardware system 200, and it is noted that each element and the operation thereof may be different from those in the actual system.

As illustrated in FIG. 5, the hardware system 2000 according to an embodiment of the present disclosure may include a processor unit 2100, a memory interface unit 2200, a peripheral device interface unit 2300, and a power unit 2400 (corresponding to the “power unit” of FIG. 4) configured to receive driving power from another device connected to constant power through a Universal Serial Bus (USB) interface.

The elements within the hardware system 2000 may be individual elements, or may be integrated into one or more integrated circuits or combined by a bus system (not shown).

The bus system corresponds to abstractions indicating one or more individual physical buses, communication lines/interfaces, multi-drop, and/or point-to-point connections connected by appropriate bridges, adaptors, and/or controllers.

The processor unit 2100 may serve to execute various software modules stored in the memory unit 2210 by communicating with the memory unit 2210 through the memory interface unit 2200 in order to perform various functions in the hardware system.

The memory unit 2210 may store the generator 21 and the transmitter 22, which are the core elements of the ordering device 20 described with reference to FIG. 4, in the software module form, and may further store an Operating System (OS).

The operating system (for example, an embedded operating system such as iOS, Android, Darwin, RTXC, LINUX, UNIX, OSX, WINDOWS, or VxWorks) includes various procedures for controlling and managing general system tasks (for example, memory management, storage device control, and power management), an instruction set, a software component, and/or a driver, and serves to make communication between various hardware modules and software modules easy.

For reference, the memory unit 2210 may include a cache, a main memory, and a secondary memory, but is not limited thereto, and may include a memory layer structure. The memory layer structure may be implemented through a predetermined combination of, for example, RAM (for example, SRAM, DRAM, or DDRAM), ROM, FLASH, a magnetic and/or optical storage device (for example, a disk drive, a magnetic tape, a Compact Disk (CD), and a Digital Video Disc (DVD)).

The peripheral interface unit 2300 enables communication between the processor unit 2100 and peripheral devices.

The peripheral devices provide different functions to the hardware system 2000, and may include, for example, a first communication unit 2310 (corresponding to the “first communication unit” of FIG. 4) and a second communication unit 2320 (corresponding to the “second communication unit” of FIG. 4) according to an embodiment of the present disclosure.

The first communication unit 2310 serves to provide a function of communication with the ordering device 10 and the second communication unit 2320 serves to provide a function of communication with the service server 40. To this end, each of them may include, for example, an antenna system, an RF transceiver, one or more amplifiers, a tuner, one or more oscillators, a digital signal processor, a CODEC chipset, and a memory, but is not limited thereto, and may include a known circuit for performing the function.

For reference, communication schemes supported by the first communication unit 2310 may include Bluetooth Low Energy (BLE), corresponding to a first communication scheme, and communication schemes supported by the second communication unit 2310 may include a Wi-Fi communication scheme, corresponding to a second communication scheme.

As a result, according to the above configuration, each element within the hybrid device 20 stored in the software module form in the memory unit 1210 may be linked to the first communication unit 2310 and the second communication unit 2320 through the memory interface unit 2200 and the peripheral device interface unit 2300 in the form of instructions executed by the processor 2100 based on driving power supplied by the power unit 2400, thereby transferring the order packet information generated by the ordering device 10 to the service server 40.

Hereinafter, for convenience of description, each element of the hybrid device 20 will be described with reference to FIG. 5 based on a linkage with the hardware system 2000.

The receiver 21 performs a function of receiving order packet information.

More specifically, when order packet information, generated when button input is made through the ordering device 10, is received from the ordering device 10 according to a first communication scheme, for example, Bluetooth Lower Energy (BLE) supported by the first communication unit 2310, the receiver 21 transmits the received order packet information to the transmitter 22.

The transmitter 22 performs a function of transmitting order packet information.

More specifically, when the order packet information is received from the receiver 21, the transmitter 12 makes a request for processing the order packet information by transmitting the received order packet information to the service server 40 according to a second communication scheme, for example, a Wi-Fi communication scheme supported by the second communication unit 2320.

In connection with this, when the order packet information transmitted from the hybrid device 20 according to the second communication scheme is received through the wireless relay device 30, the service server 40 may identify whether there is user consent to process the order packet information from the user terminal 50, and when the user consent is confirmed, may process the order packet information.

The identification of whether the user consent to process the order packet information may be performed, through, for example, a pop-up push message based on an application within the user terminal 50.

The hybrid device 20 according to an embodiment of the present disclosure has been described above, and the service server 40 will next be described below.

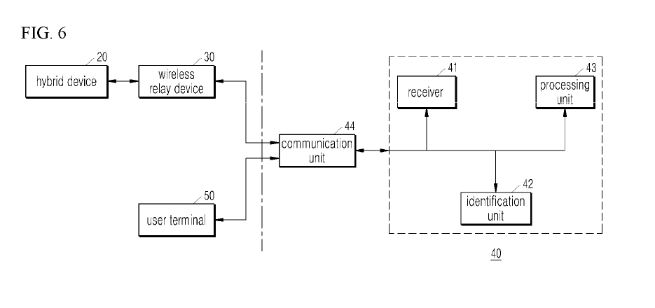

The service server 40 of FIG. 6 according to an embodiment of the present disclosure may include a receiver 41 configured to receive order packet information, an identification unit 42 configured to identify whether there is user consent, and a processing unit 43 configured to process order packet information.

All or at least some of the core elements of the service server 400, including the receiver 41, the identification unit 42, and the processing unit 43, may be implemented in the form of a software module or a hardware module executed by the processor or in the form of a combination of the software module and the hardware module.

The software module may be understood as an instruction executed by the processor for processing calculations within the service server 40, and the instruction may take the form of being installed in the memory within the service server 40.

Meanwhile, the service server 40 according to an embodiment of the present disclosure may further include a communication unit 44, which is an RF module supporting communication with the hybrid device 20 and the user terminal 50 as well as the above-described elements.

As a result, the service server 40 according to an embodiment of the present disclosure may receive the order packet information generated by the ordering device 10 through the core elements including the receiver 41, the identification unit 42, and the processing unit 43 and process the received order packet information, and the core elements of the service server 40 for implementing the same will be described below in more detail.

The receiver 41 performs a function of receiving order packet information.

More specifically, the receiver 41 receives order packet information, generated when button input is made through the ordering device 10, from the hybrid device 20.

At this time, the receiver 41 may receive the order packet information from the hybrid device 20 according to a second communication scheme, for example, a Wi-Fi communication scheme supported by the wireless relay device 30.

In connection with this, when the order packet information according to the button input is received from the ordering device 10 according to the first communication scheme, the hybrid device 20 may make a request for processing the order packet information by transmitting the received order packet information to the service server 40 according to the second communication scheme, for example, a Wi-Fi communication scheme, which is different from the first communication scheme and is supported by the wireless relay device 30.

The identification unit 42 performs a function of identifying whether there is user consent.

More specifically, when the order packet information transmitted from the hybrid device 20 is received through the wireless relay device 30, the identification unit 42 identifies whether there is user consent to process the order packet information from the user terminal 50.

At this time, the identification unit 42 may identify whether there is user consent to process the order packet information by transmitting a popup push message based on an application within the user terminal 50 to the user terminal 50.

The processing unit 43 performs a function of processing order packet information.

More specifically, when the user consent to process the order packet information is identified from the user terminal 50, the processing unit 43 processes an quick purchase of a product mapped to device identification information (for example, a MAC address or serial number) of the ordering device 10 without additional intervention through the user terminal 50 (selecting a product, inputting a payment means, or inputting the delivery destination) by processing the order packet information.

As a result, when the service server 40 according to an embodiment of the present disclosure processes order packet information generated by the ordering device 10, the service server 40 has only to identify whether there is user consent through the popup push message based on the application with respect to the user terminal 50, so that the ordering device 10 can be used without any pairing procedure between the ordering device 10 and the user terminal 50.

It has been described that each element within the service server 40 may be implemented in the form of a software module or a hardware module executed by the processor or in the form of a combination of the software module and the hardware module.

As described above, the software module and the hardware module executed by the processor and the combination of the software module and the hardware module may be implemented by an actual hardware system (for example, a computer system).

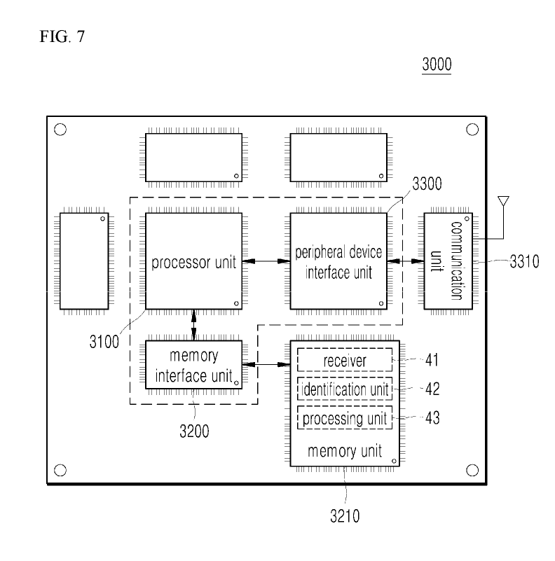

Accordingly, hereinafter, a hardware system 3000 for implementing the service server 40 according to an embodiment of the present disclosure will be described with reference to FIG. 7.

For reference, the following description is an example for implementing a hardware system 3000 through each element within the service server 40, and it is noted that each element and the operation thereof may be different from those in an actual system.

As illustrated in FIG. 7, the hardware system 3000 according to an embodiment of the present disclosure may include a processor unit 3100, a memory interface unit 3200, and a peripheral device interface unit 3300.

The elements within the hardware system 3000 may be individual elements, or may be integrated into one or more integrated circuits or combined through a bus system (not shown).

The bus system corresponds to abstractions indicating one or more individual physical buses, communication lines/interfaces, multi-drop, and/or point-to-point connections connected by appropriate bridges, adaptors, and/or controllers.

The processor unit 3100 may serve to execute various software modules stored in the memory unit 3210 by communicating with the memory unit 3210 through the memory interface unit 3200 in order to perform various functions in the hardware system.

The memory unit 3210 may store the receiver 41, the identification unit 42, and the processing unit 43, which are the core elements of the service server 40 described with reference to FIG. 6, in the software module form, and may further store an Operating System (OS).

The operating system (for example, an embedded operating system such as iOS, Android, Darwin, RTXC, LINUX, UNIX, OSX, WINDOWS, or VxWorks) includes various procedures for controlling and managing general system tasks (for example, memory management, storage device control, and power management), an instruction set, a software component, and/or a driver, and serves to make communication between various hardware modules and software modules easy.

For reference, the memory unit 3210 includes a cache, a main memory, and a secondary memory, but is not limited thereto, and may include a memory layer structure. The memory layer structure may be implemented through a predetermined combination of, for example, RAM (for example, SRAM, DRAM, or DDRAM), ROM, FLASH, a magnetic and/or optical storage device (for example, a disk drive, a magnetic tape, a Compact Disk (CD), and a Digital Video Disc (DVD)).

The peripheral interface unit 3300 enables communication between the processor unit 3100 and peripheral devices.

The peripheral devices provide different functions to the hardware system 3000, and may include, for example, a communication unit 3310 (corresponding to the “communication unit” of FIG. 6) according to an embodiment of the present disclosure.

The communication unit 3310 serves to support communication with the hybrid device 20 through the wireless relay device 30 and provide a function of communication with the user terminal 50. To this end, the communication unit 3310 may include, for example, an antenna system, an RF transceiver, one or more amplifiers, a tuner, one or more oscillators, a digital signal processor, a CODEC chipset, and a memory, but is not limited thereto, and may include a known circuit for performing the function.

For reference, communication schemes supported by the communication unit 3310 may include a Wi-Fi communication scheme, corresponding to a second communication scheme.

As a result, according to the above configuration, each element within the service server 40 stored in the software module form in the memory unit 3210 may be linked to the communication unit 3310 through the memory interface unit 3200 and the peripheral device interface unit 3300 in the form of instructions executed by the processor 3100, thereby processing the order packet information generated by the ordering device 10.

Hereinafter, for convenience of description, each element of the service server 40 will be described based on a linkage with the hardware system 3000 with reference to FIG. 7.

The receiver 41 performs a function of receiving order packet information.

More specifically, the receiver 41 receives order packet information generated when button input is made through the ordering device 10 from the hybrid device 20 through the communication unit 3310 and transfers the generated order packet information to the identification unit 42.

At this time, the receiver 41 may receive the order packet information from the hybrid device 20 according to a second communication scheme, for example, a Wi-Fi communication scheme supported by the wireless relay device 30.

In connection with this, when the order packet information according to the button input is received from the ordering device 10 according to the first communication scheme, the hybrid device 20 may make a request for processing the order packet information by transmitting the received order packet information to the service server 40 according to the second communication scheme, for example, a Wi-Fi communication scheme, which is different from the first communication scheme and is supported by the wireless relay device 30.

The identification unit 42 performs a function of identifying whether there is user consent.

More specifically, when the order packet information transmitted from the hybrid device 20 is received, the identification unit 42 identifies whether there is user consent to process the order packet information from the user terminal 50 on the basis of identification information (for example, a phone number or application identification information) mapped to device identification information within the order packet information and transfers the identification result to the processing unit 43.

At this time, the identification unit 42 may identify whether there is user consent to process the order packet information by transmitting a popup push message based on an application within the user terminal 50 to the user terminal 50 through the communication unit 3310.

The processing unit 43 performs a function of processing order packet information.

More specifically, when the user consent to process the order packet information is identified from the user terminal 50, the processing unit 43 processes quick purchase of a product mapped to device identification information (for example, a MAC address or serial number) of the ordering device 10 without additional intervention through the user terminal 50 (selecting a product, inputting a payment means, or inputting the delivery destination) by processing the order packet information.

As described above, according to each element within the smart order system according to an embodiment of the present disclosure, since a pairing procedure between the ordering device 10 and the user device 50 is not required in order to use the ordering device 10 supporting the quick product purchase through button input alone, it is possible to improve user convenience and also minimize battery consumption in the user terminal 50 according to repetition of the pairing procedure.

Hereinafter, the smart order system according to an embodiment of the present disclosure and an operation flow of each element within the system will be described.

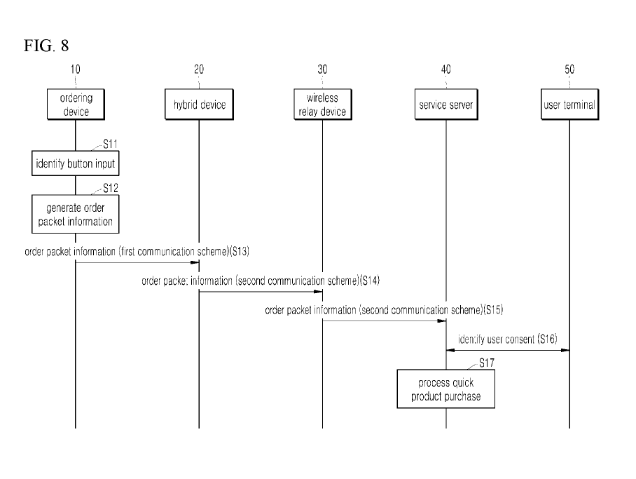

FIG. 8 illustrates an operation flow in the smart order system according to an embodiment of the present disclosure.

First, when button input according to an quick purchase request is identified in step S11, the ordering device 10 generates order packet information for making a request for quick product purchase in step S12.

At this time, when the button input is identified, the ordering device 10 may minimize power consumption of battery power by generating order packet information through a method of switching an operation mode of the ordering device 10, which is normally in a sleep mode, to an active mode.

Then, the ordering device 10 transmits the order packet information generated according to the button input to the hybrid device 20 according to a first communication scheme, for example, Bluetooth Low Energy (BLE), in step S13.

When the order packet information transmitted according to the first communication scheme is received from the ordering device 10, the hybrid device 20 makes a request for processing the order packet information by transmitting the received order packet information to the service server 40 according to a second communication scheme, for example, a Wi-Fi communication scheme, in steps S14 and S15.

Further, when the order packet information transmitted according to the second communication scheme is received from the hybrid device 20 through the wireless relay device 30, the service server 40 identifies whether there is user consent to process the order packet information from the user terminal 50 in step S16.

At this time, the identification unit 42 may identify whether there is user consent to process the order packet information by transmitting a popup push message based on an application within the user terminal 50 to the user terminal 50.

Thereafter, when the user consent to process the order packet information is identified from the user terminal 50, the service server 40 processes quick purchase of a product mapped to device identification information (for example, a MAC address or serial number) of the ordering device 10 without additional intervention through the user terminal 50 (selecting a product, inputting a payment means, or inputting the delivery destination) by processing the order packet information in step S17.

The operation flow in the smart order system according to an embodiment of the present disclosure has been described above and an operation flow in the ordering device 10 will next be described below.

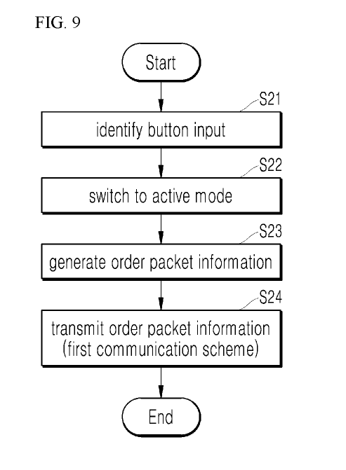

FIG. 9 is a flowchart illustrating the operation of the ordering device 10 according to an embodiment of the present disclosure.

First, when button input according to an quick purchase request is identified in step S21, the generator 11 generates order packet information for making a request for quick product purchase after switching an operation mode of the ordering device 10, which is normally in a sleep mode, to an active mode in steps S22 and S23.

As described above, when the button input is identified, the generator 11 may minimize power consumption of battery power by generating the order packet information through a method of switching an operation mode of the ordering device 10, which is normally in a sleep mode, to an active mode.

Further, when the order packet information according to the button input is generated, the transmitter 12 transmits the order packet information generated in step S23 to the hybrid device 20 according to a first communication scheme, for example, a Bluetooth Low Energy (BLE) communication scheme.

At this time, when the order packet information is received according to the first communication scheme, the hybrid device 20 makes a request for processing the order packet information by transmitting the received order packet information to the service server 40 according to a second communication scheme, for example, a Wi-Fi communication scheme, which is different from the first communication scheme.

Meanwhile, when the order packet information transmitted from the hybrid device 20 according to the second communication scheme is received through the wireless relay device 30, the service server 40 may identify whether there is user consent to process the order packet information from the user device 50, and when the user consent is confirmed, process the order packet information.

The operation flow in the ordering device 10 according to an embodiment of the present disclosure has been described above, and an operation flow in the hybrid device 20 will next be described below.

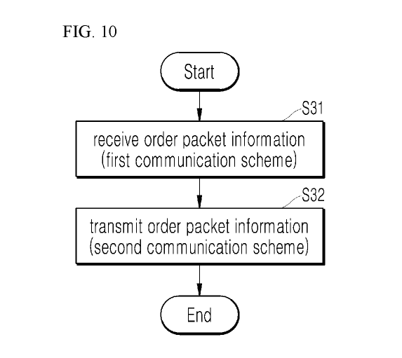

FIG. 10 is a flowchart illustrating the operation of the hybrid device 20 according to an embodiment of the present disclosure.

First, the receiver 21 receives order packet information, generated when button input is made through the ordering device 10, from the ordering device 10 in step S31.

At this time, the receiver 21 receives order packet information from the ordering device 10 through a first communication scheme, for example, Bluetooth Low Energy (BLE), consuming a relatively small amount of power for transmitting order packet information compared to a second communication scheme, which is a communication scheme between the hybrid device 20 and the service server 40.

In connection with this, when button input from the user is identified, the ordering device 10 generates order packet information and transmits the generated order packet information to the hybrid device 20 according to the first communication scheme, for example, Bluetooth Low Energy (BLE).

Thereafter, when the order packet information according to the button input is received from the ordering device 10 according to the first communication scheme, the transmitter 12 makes a request for processing the order packet information by transmitting the received order packet information to the service server 40 according to a second communication scheme, for example, a Wi-Fi communication scheme, which is different from the first communication scheme and is supported by the wireless relay device 30 in step S32.

In connection with this, when the order packet information transmitted from the hybrid device 20 according to the second communication scheme is received through the wireless relay device 30, the service server 40 may identify whether there is user consent to process the order packet information from the user terminal 50, and when the user consent is confirmed, process the order packet information.

The operation flow of the hybrid device 20 according to an embodiment of the present disclosure has been described above, and the operation flow of the service server 40 will next be described below.

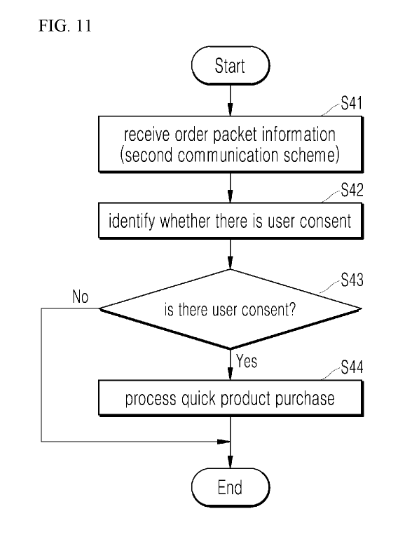

FIG. 11 is a flowchart illustrating the operation of the service server 40 according to an embodiment of the present disclosure.

First, the receiver 41 receives order packet information, which is generated when button input is made through the ordering device 10 from the hybrid device 20 in step S41.

At this time, the receiver 41 may receive the order packet information from the hybrid device 20 according to a second communication scheme, for example, a Wi-Fi communication scheme supported by the wireless relay device 30.

In connection with this, when the order packet information according to the button input is received from the ordering device 10 according to the first communication scheme, the hybrid device 20 may make a request for processing the order packet information by transmitting the received order packet information to the service server 40 according to the second communication scheme, for example, a Wi-Fi communication scheme, which is different from the first communication scheme and is supported by the wireless relay device 30.

Further, when the order packet information transmitted from the hybrid device 20 is received through the wireless relay device 30, the identification unit 42 identifies whether there is user consent to process the order packet information from the user terminal 50 in step S42.

At this time, the identification unit 42 may identify whether there is user consent to process the order packet information by transmitting a popup push message based on an application within the user terminal 50 to the user terminal 50.

Thereafter, when the user consent to process the order packet information is identified from the user terminal 50, the processing unit 43 processes quick purchase of a product mapped to device identification information (for example, a MAC address or serial number) of the ordering device 10 without additional intervention through the user terminal 50 (selecting a product, inputting a payment means, or inputting the delivery destination) by processing the order packet information.

As described above, according to the operation flow of each element within the smart order system according to an embodiment of the present disclosure, since a pairing procedure between the ordering device 10 and the user device 50 is not required in order to use the ordering device 10 supporting quick product purchase through button input alone, it is possible to improve user convenience and also minimize battery consumption by the user terminal 50 attributable to repetition of the pairing procedure.

The implementations of the functional operations and subject matter described in the present disclosure may be realized by a digital electronic circuit, by the structure described in the present disclosure and the equivalent including computer software, firmware, or hardware including, or by a combination of one or more thereof. Implementations of the subject matter described in the specification may be implemented in one or more computer program products, that is, one or more modules related to a computer program command encoded on a tangible program storage medium to control an operation of a processing system or the execution by the operation.

A computer-readable medium may be a machine-readable storage device, a machine-readable storage substrate, a memory device, a composition of materials influencing a machine-readable radio wave signal, or a combination of one or more thereof.

In the specification, the term “system” or “device”, for example, covers a programmable processor, a computer, or all kinds of mechanisms, devices, and machines for data processing, including a multiprocessor and a computer. The processing system may include, in addition to hardware, a code that creates an execution environment for a computer program when requested, such as a code that constitutes processor firmware, a protocol stack, a database management system, an operating system, or a combination of one or more thereof.

A computer program (also known as a program, software, software application, script, or code) can be written in any form of programming language, including compiled or interpreted languages, declarative or procedural languages, and it can be deployed in any form, including as a stand-alone program or module, a component, subroutine, or another unit suitable for use in a computer environment. A computer program may, but need not, correspond to a file in a file system. A program can be stored in a single file provided to the requested program, in multiple coordinated files (for example, files that store one or more modules, sub-programs, or portions of code), or in a portion of a file that holds other programs or data (for example, one or more scripts stored in a markup language document). A computer program can be deployed to be executed on one computer or on multiple computers that are located at one site or distributed across a plurality of sites and interconnected by a communication network.

A computer-readable medium suitable for storing a computer program command and data includes all types of non-volatile memories, media, and memory devices, for example, a semiconductor memory device such as an EPROM, an EEPROM, and a flash memory device, and a magnetic disk such as an external hard disk or an external disk, a magneto-optical disk, a CD-ROM, and a DVD-ROM disk. A processor and a memory may be added by a special purpose logic circuit or integrated into the logic circuit.

Implementations of the subject matter described in the specification may be implemented in a calculation system including a back-end component such as a data server, a middleware component such as an application server, a front-end component such as a client computer having a web browser or a graphic user interface which can interact with the implementations of the subject matter described in the specification by the user, or all combinations of one or more of the back-end, middleware, and front-end components. The components of the system can be mutually connected by any type of digital data communication such as a communication network or a medium.

While the specification contains many specific implementation details, these should not be construed as limitations on the scope of any disclosure or of what may be claimed, but rather as descriptions of features that may be specific to particular embodiments of particular disclosures. Certain features that are described in the specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

In addition, in the specification, the operations are illustrated in a specific sequence in the drawings, but it should not be understood that the operations are performed in the shown specific sequence or that all shown operations are performed in order to obtain a preferable result. In a specific case, a multitasking and parallel processing may be preferable. Furthermore, it should not be understood that a separation of the various system components of the above-mentioned implementation is required in all implementations. In addition, it should be understood that the described program components and systems usually may be integrated in a single software package or may be packaged in a multi-software product.

As described above, specific terms disclosed in the specification do not intend to limit the present disclosure. Therefore, while the present disclosure was described in detail with reference to the above-mentioned examples, a person skilled in the art may modify, change and transform some parts without departing a scope of the present disclosure. The scope of the present disclosure is defined by the appended claims to be described later, rather than the detailed description. Accordingly, it will be appreciated that all modifications or variations derived from the meaning and scope of the appended claims and their equivalents are included in the range of the present disclosure.

What is claimed is:

1. A hybrid device comprising:
a processor configured to process order packet information received from an ordering device; and
a memory configured to store processor-readable instructions that, when executed by the processor, cause the processor to:
receive the order packet information generated by the ordering device according to a first communication scheme; and
transmit the order packet information to the service server according to a second communication scheme that is different from the first communication scheme when the order packet information is received such that the service server processes the order packet information.

2. The hybrid device of claim 1, wherein an amount of power consumption required by the first communication scheme to transmit the order packet information is less than an amount of power consumption required by the second communication scheme to transmit the order packet information.

3. The hybrid device of claim 1, wherein the first communication scheme is a Bluetooth Low Energy (BLE) communication scheme and the second communication scheme is a Wi-Fi communication scheme.

4. The hybrid device of claim 3, wherein the hybrid device further comprises:
a first communicator configured to receive the order packet information through the Bluetooth Low Energy (BLE) communication scheme; and
a second communicator configured to transmit the order packet information through the Wi-Fi communication scheme.

5. The hybrid device of claim 1, further the hybrid device further comprises:
a power configured to receive driving power of the hybrid device through a Universal Serial Bus (USB) interface from another device receiving power.

6. The hybrid device of claim 1, wherein the memory configured to store processor-readable instructions that, when executed by the processor, cause the processor to determine whether there is a user consent to process the order packet information from the user terminal when the order packet information is transmitted according to the second communication scheme.

7. The hybrid device of claim 6, wherein the order packet information is processed when the memory configured to store processor-readable instructions that, when executed by the processor, cause the processor to determine that there is the user consent to process the order packet information.

8. An ordering device comprising:
a processor configured to process a purchase request; and
a memory configured to store processor-readable instructions that, when executed by the processor, cause the processor to:
generate order packet information when button input related to the quick purchase request is identified; and
transmit the order packet information to the hybrid device according to a first communication scheme such that the hybrid device transmits the order packet information to a service server according to a second communication scheme that is different from the first communication scheme.

9. The ordering device of claim 8, wherein an amount of power consumption required by the first communication scheme to transmit the order packet information is less than an amount of power consumption required by the second communication scheme to transmit the order packet information.

10. The ordering device of claim 8, wherein the first communication scheme is a Bluetooth Low Energy (BLE) communication scheme.

11. The ordering device of claim 8, wherein the ordering device further comprises:
a power configured to receive driving power of the ordering device from battery power.

12. A method of operating a hybrid device, the method comprising:
receiving the order packet information generated by the ordering device according to a first communication scheme; and
transmitting the order packet information to the service server according to a second communication scheme that is different from the first communication scheme when the order packet information is received such that the service server processes the order packet information.

13. The method of claim 12, wherein an amount of power consumption required by the first communication scheme to transmit the order packet information is less than an amount of power consumption required by the second communication scheme to transmit the order packet information.

14. The method of claim 12, wherein the first communication scheme is a Bluetooth Low Energy (BLE) communication scheme and the second communication scheme is a Wi-Fi communication scheme.

15. The method of claim 12, further comprising:
receiving driving power of the hybrid device through a Universal Serial Bus (USB) interface from another device receiving power.
